(19) United States
(12) Patent Application Publication
(10) Pub. No.: US 2016/0100046 A1
(43) Pub. Date: Apr. 7, 2016

(54) SYSTEMS AND METHODS FOR DISABLING RECORDING FUNCTIONALITY IN A SECURE AREA

(71) Applicants: Michael Meru, Draper, UT (US); Alan Wilson, St. George, UT (US); Nathan Ellison, Syracuse, UT (US)

(72) Inventors: Michael Meru, Draper, UT (US); Alan Wilson, St. George, UT (US); Nathan Ellison, Syracuse, UT (US)

(21) Appl. No.: 14/506,454

(22) Filed: Oct. 3, 2014

(51) Int. Cl. H04M 1/725; H04W 12/02; H04W 4/00; G01S 19/13; H04W 4/02

(52) U.S. Cl. CPC H04M 1/72572; G01S 19/13; H04M 1/72577; H04W 4/021; H04W 4/008; H04W 12/02

(57) ABSTRACT

A system for disabling recording functionality in a secure area. The system includes a beacon. The beacon configured to define the perimeter of a secure area and instruct electronic devices within the secure area to inhibit recording functions. The system also includes an electronic device in electronic communication with the beacon.

### CROSS-REFERENCE TO RELATED APPLICATIONS

Not applicable.

### BACKGROUND OF THE INVENTION

With the advent of AR, OHMD, Wearable Technology, and Wearable Computers, the already heightened concerns over security and privacy in public and private arenas are significantly increased. Measures have been taken in many arenas to prohibit the use of mobile devices in the name of security and privacy, and similar regulations are now starting to arise for the use of these devices as well. The most common thought and simple solution is to simply prohibit the use of such devices in these areas, though this stymies the advancement of these technologies and intrudes on an individual's use of other facets of the device.

The secured areas the inventors felt would warrant and benefit the public from the use of such camera disabling would be public/private restrooms, testing centers, university classrooms and laboratories, clothing optional locations, and all locations where the security of individuals or proprietary information exists. Disabling the camera feature then prohibits the taking of photos of unsuspecting individuals or minors in indecent or compromised scenarios, hinders cheating and unethical acts, as well as protects secure locations.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a system for disabling recording functionality in a secure area. The system includes a beacon. The beacon configured to define the perimeter of a secure area and instruct electronic devices within the secure area to inhibit recording functions. The system also includes an electronic device in electronic communication with the beacon.

Another example embodiment includes a system for disabling recording functionality in a secure area. The system includes a first beacon. The first beacon configured to define the perimeter of a secure area and instruct electronic devices within the secure area to inhibit recording functions. The system also includes a second beacon. The second beacon configured to define the perimeter of a secure area and instruct electronic devices within the secure area to inhibit recording functions. The system further includes an electronic device in electronic communication with the beacon.

Another example embodiment includes a method of disabling recording functionality in a secure area. The method includes setting a perimeter, wherein the perimeter defines a secure area and defining a protocol for the secure area defined by the perimeter, wherein the protocol which activities are to be blocked within the secure area. The method also includes detecting any electronic devices within the secure area and sending the protocol to the detected electronic devices.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates an example of a system for disabling recording functionality in a secure area;

FIG. 2 is a flow chart illustrating a method of disabling recording functionality in a secure area;

FIG. 3 illustrates a single beacon configuration;

FIG. 4 illustrates an example of a dual beacon configuration;

FIG. 5 illustrates an example of a tri-beacon configuration;

FIG. 6 illustrates an example of a single beacon gateway configuration;

FIG. 7 illustrates an example of a dual beacon gateway configuration; and

FIG. 8 illustrates an example of a suitable computing environment in which the invention may be implemented.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

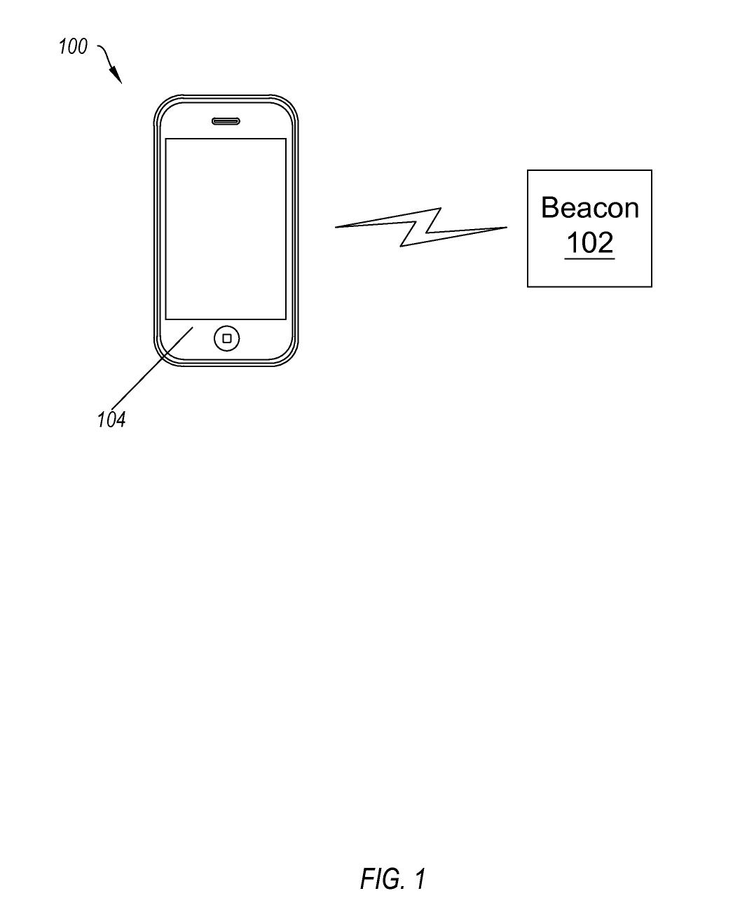

FIG. 1 illustrates an example of a system 100 for disabling recording functionality in a secure area. The system 100 can be used to ensure privacy when desired. For example, in meetings where sensitive information is discussed, to prevent piracy of proprietary information, to control document flow, or to otherwise preserve privacy. The recording technology to be disabled can include cameras or audio recording devices. Further, the system 100 can allow a user to customize the area where the recording devices will be disabled.

FIG. 1 shows that the system 100 can include a beacon 102. The beacon 102 identifies the secure area. I.e., the beacon 102 identifies the area within which recording functionality should be disabled. The beacon 102 can instruct any device which receives a signal to disable recording or can indicate how the secure area can be identified (e.g., provide GPS coordinates for which recording should be disabled). The beacon 102 can include any device capable of instructing an external device to disable recording. For example, the beacon 102 can include a transmitter that communicates via Bluetooth low energy (“BLE”) signals, iBeacons or any other device which automatically connects to desired electronic devices. Bluetooth is an open wireless technology standard for exchanging data over short distances (using short-wavelength radio transmissions in the ISM band from 2400-2480 MHz) from fixed and mobile devices, creating personal area networks (PANs) with high levels of security. I.e., BLE allows commands to be sent from the beacon to the electronic device and vice versa.

FIG. 1 also shows that the system 100 can include an electronic device 104. The electronic device 104 can include any device which includes a recording function. For example, the electronic device 104 can include a mobile device, computer, laptop, tablet, smart phone, augmented reality (AR), optical head-mounted display (OHMD), wearable technology, and wearable computer devices or any other electronic device. The beacon 102 can include a universally unique identifier (UUID) that the electronic device 104 will identify when the device comes in range. The beacon 102 can determine the location of the electronic device 104 (e.g., by detecting the transmitter power (txPower) from the electronic device 104) or by having the electronic device self-report location and/or can transmit a protocol to be followed when the electronic device 104 resides within the secure area. The beacon 102 will also instruct the electronic device 104 which functions to disable upon entrance to the secure area. Once the device exits the secure area, the recoding function will be re-enabled.

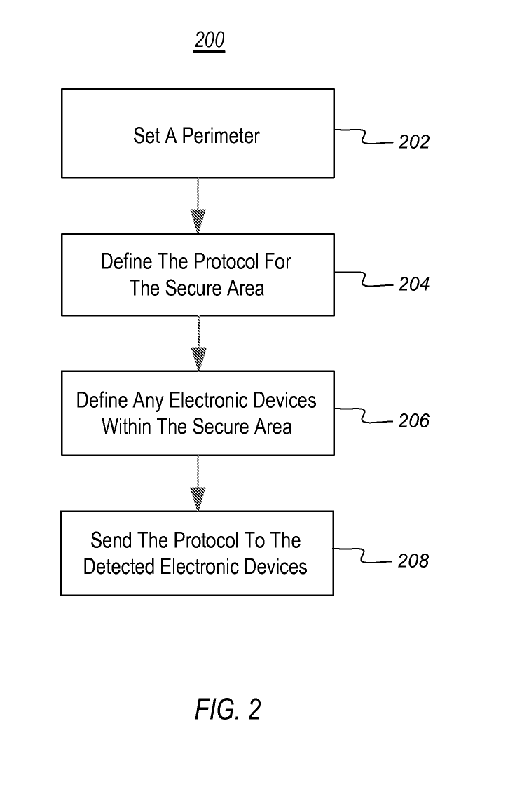

FIG. 2 is a flow chart illustrating a method 200 of disabling recording functionality in a secure area. In at least one implementation, the method can be implemented using a blocking system, such as the system 100 of FIGS. 1-3. Therefore, the method 200 will be described, exemplarily, with reference to the system 100 of FIGS. 1-3. Nevertheless, one of skill in the art can appreciate that the method 200 can be used with systems other than the system 100 of FIGS. 1-3.

FIG. 2 shows that the method 200 can include setting 202 a perimeter. The perimeter defines the area in which recoding is disabled and can be set 202 using one or more beacons. The beacons are configured to communicate with electronic devices within the secure area. That is, the beacons instruct electronic devices with which they are communicating to disable all or some recording functions. As used in the specification and the claims, the phrase “configured to” denotes an actual state of configuration that fundamentally ties recited elements to the physical characteristics of the recited structure. As a result, the phrase “configured to” reaches well beyond merely describing functional language or intended use since the phrase actively recites an actual state of configuration.

FIG. 2 also shows that the method 200 can include defining 204 a protocol for the secure area defined by the perimeter. The protocol determines which activities are to be blocked and which are allowed. For example, the protocol may disable the camera only or may block audio recording only or any combination desired by the user. The protocol may also determine when activities are to be blocked. For example, a conference room may normally not prevent any activity unless activated or may block activities only during business hours, etc.

FIG. 2 further shows that the method 200 can include detecting 206 any electronic devices within the secure area. Detecting 206 any electronic devices within the secure area occurs automatically as the device enters. That is, the software of the electronic device receives a signal from the beacon(s) and establishes communication with the beacon(s). Part of the communication is determining position relative to the beacon(s) in order to determine whether the electronic device is within the secure area (as described below).

FIG. 2 additionally shows that the method 200 can include sending 208 the protocol to the detected electronic devices. That is, it is the electronic device which carries out the actual block of recording by deactivating the appropriate recording mechanism on the device. Therefore, the instruction on which recording to disable must be sent 208 to the electronic device. This communication may be sent prior to the device actually entering the secure area to allow the device to block recording when within the secure area.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

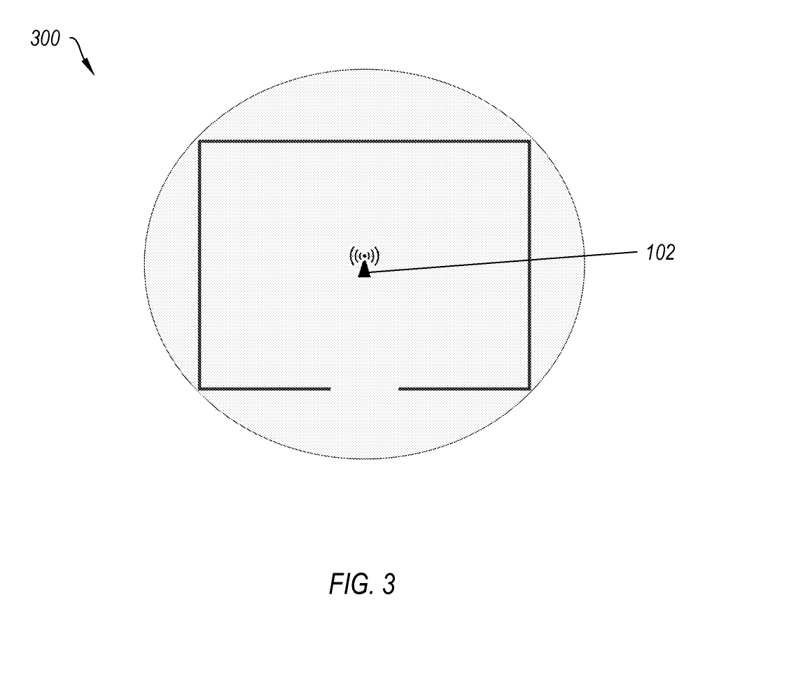

FIG. 3 illustrates a single beacon configuration 300. The single beacon configuration 300 can include only one beacon 102 which broadcasts far enough that an entire secure area resides within the broadcast region of the beacon 102. The single beacon configuration 300 disables all electronic devices within the signal of the beacon 102. This is functional, but not nearly as precise, thus creating a dead zone outside of the secure area, and disabling cameras that may not be in the secure area and/or may miss some areas of the secure area (e.g., corners of a room). Such imprecision may be acceptable if users are on alert for suspicious or abnormal behavior (e.g., taking pictures from a corner).

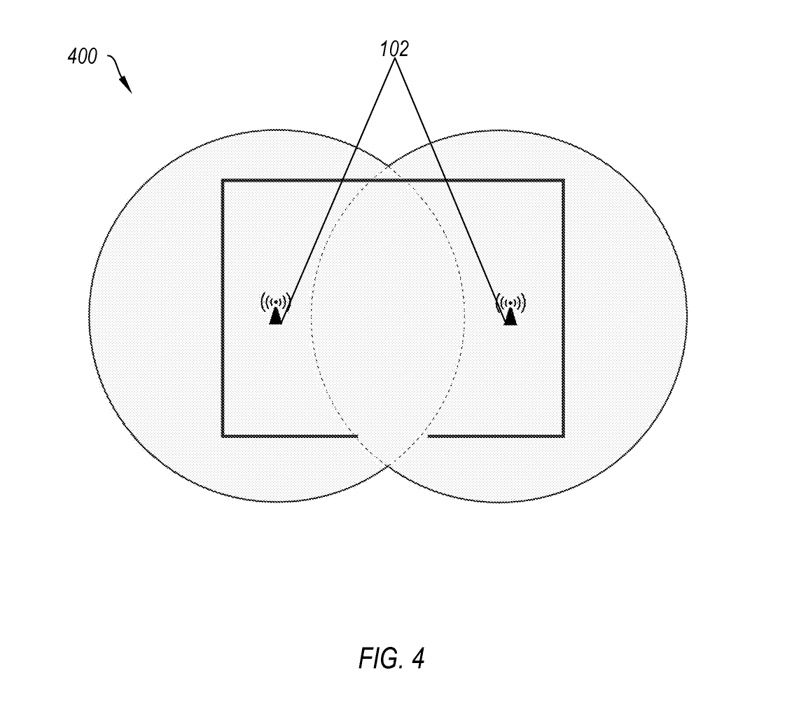

FIG. 4 illustrates an example of a dual beacon configuration 400. The dual beacon configuration 400 allows the electronic device to more precisely determine its location relative to the beacons 102. I.e., the electronic device and/or the beacons 102 can determine the precise location of the electronic device relative the beacons 102 using either triangulation or trilateration. The dual beacon configuration 400 allows a smaller radius of dead zone outside of the secure area.

Triangulation is the process of determining the location of the electronic device by measuring angles to it from known points at either end of a fixed baseline. I.e., the coordinates and distance of the electronic device can be found by calculating the length of one side of a triangle, given measurements of angles and sides of the triangle formed by that location and two other known reference points. In contrast, trilateration is the process of determining absolute or relative locations of the electronic device by measurement of distances (it does not involve the measurement of angles), using the geometry of circles, spheres or triangles. In two-dimensional geometry, it is known that if a point lies on two circles, then the circle centers and the two radii provide sufficient information to narrow the possible locations down to two (additional information may narrow the possibilities down to one unique location). In three-dimensional geometry, when it is known that a point lies on the surfaces of three spheres, then the centers of the three spheres along with their radii provide sufficient information to narrow the possible locations down to no more than two (unless the centers lie on a straight line).

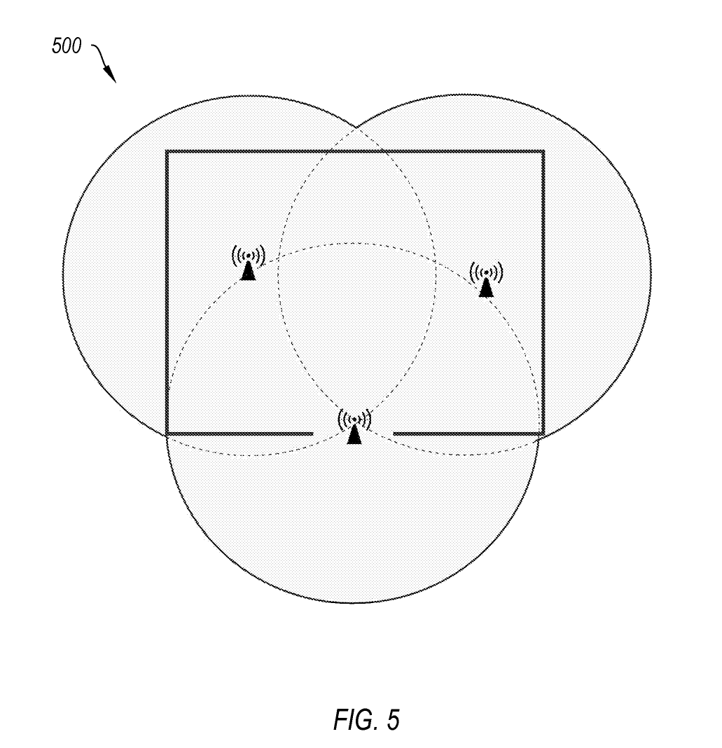

FIG. 5 illustrates an example of a tri-beacon configuration 500. The tri-beacon configuration 500 allows precise pinpointing of the electronic device to within inches or better, thus enabling the secure area to be defined with great precision and virtually eliminates dead areas and or mistakes in disabling recording functions. The recording function would be disabled upon entering into the secure area would remain disabled as long as the electronic device is in the secure area, and would be re-enabled upon exiting.

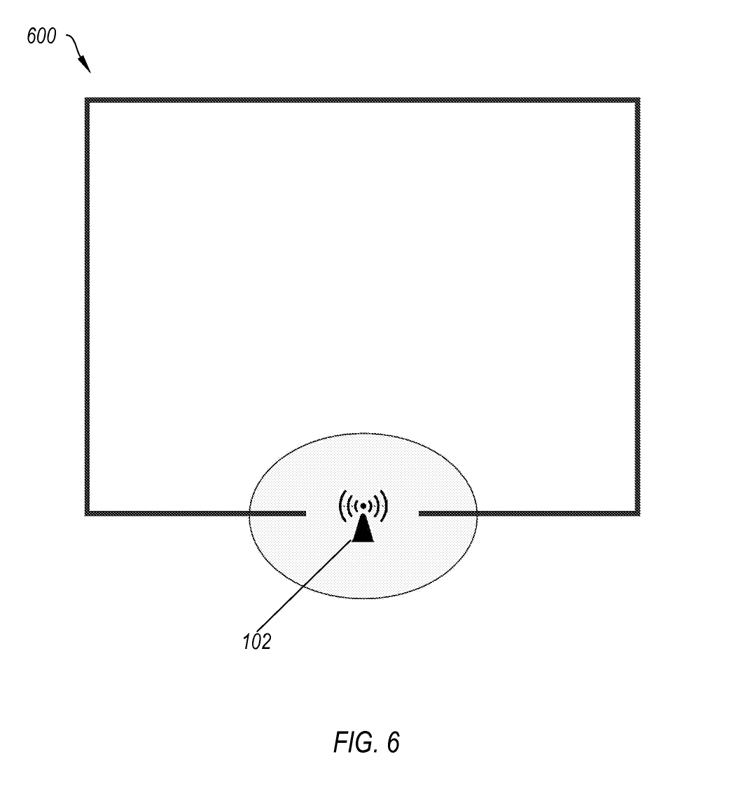

FIG. 6 illustrates an example of a single beacon gateway configuration 600. The single beacon gateway configuration 600 is similar to the single beacon configuration described in FIG. 3 in that it needs only a single beacon 102. However, the single beacon 102 covers a smaller radius and is placed only at the entry to the secure area. Thus, as users pass through the gateway into the secure area the recording function is disabled and as users pass through the gateway out of the secure area the recording function is re-enabled. However, the beacon 102 would need to successfully determine when the electronic device actually passes through the gateway, rather than just near the gateway. I.e., the beacon 102 can't disable recording functions on an electronic device which passes in front of the gateway and must detect when a user is entering and/or exiting. Identification can occur using other location functions of the electronic device. For example, the electronic device may be instructed to disable recording functions when within the secure area and have the secure area defined using GPS locations or some other system of location identification.

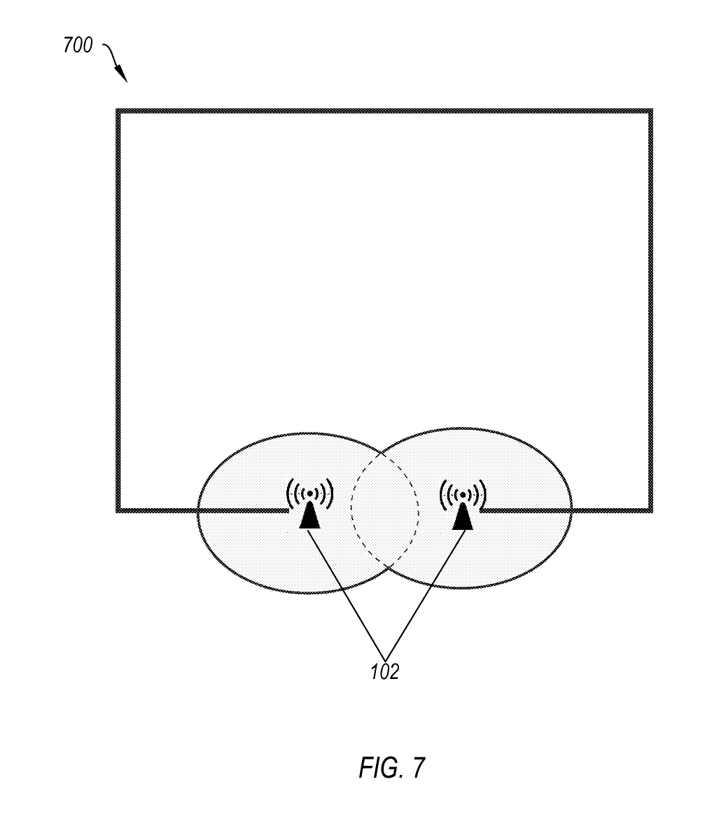

FIG. 7 illustrates an example of a dual beacon gateway configuration 700. The dual beacon gateway configuration allows for each beacon 102 to cover a smaller radius than the configuration of FIG. 6. In addition, two beacons 102 can allow the electronic device to determine the direction of the user through the gateway. I.e., triangulation or trilateration may be used to determine whether the user is entering or leaving the secure area.

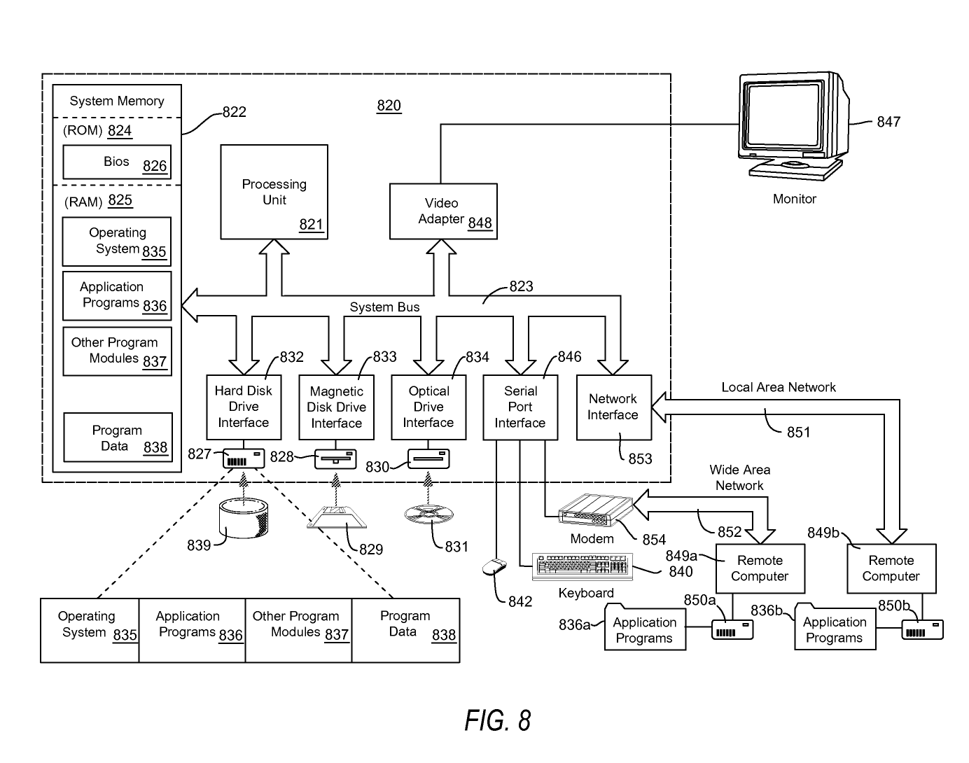

FIG. 8, and the following discussion, is intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that performs particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

One of skill in the art will appreciate that the invention may be practiced in network computing environments with many types of computer system configurations, including personal computers, hand-held devices, mobile phones, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 8, an example system for implementing the invention includes a general purpose computing device in the form of a conventional computer 820, including a processing unit 821, a system memory 822, and a system bus 823 that couples various system components including the system memory 822 to the processing unit 821. It should be noted however, that as mobile phones become more sophisticated, mobile phones are beginning to incorporate many of the components illustrated for conventional computer 820. Accordingly, with relatively minor adjustments, mostly with respect to input/output devices, the description of conventional computer 820 applies equally to mobile phones. The system bus 823 may be any of several types of bus structures including a memory bus or memory controller, a peripheral bus, and a local bus using any of a variety of bus architectures. The system memory includes read only memory (ROM) 824 and random access memory (RAM) 825. A basic input/output system (BIOS) 826, containing the basic routines that help transfer information between elements within the computer 820, such as during start-up, may be stored in ROM 824.

The computer 820 may also include a magnetic hard disk drive 827 for reading from and writing to a magnetic hard disk 839, a magnetic disk drive 828 for reading from or writing to a removable magnetic disk 829, and an optical disc drive 830 for reading from or writing to removable optical disc 831 such as a CD-ROM or other optical media. The magnetic hard disk drive 827, magnetic disk drive 828, and optical disc drive 830 are connected to the system bus 823 by a hard disk drive interface 832, a magnetic disk drive-interface 833, and an optical drive interface 834, respectively. The drives and their associated computer-readable media provide nonvolatile storage of computer-executable instructions, data structures, program modules and other data for the computer 820. Although the exemplary environment described herein employs a magnetic hard disk 839, a removable magnetic disk 829 and a removable optical disc 831, other types of computer readable media for storing data can be used, including magnetic cassettes, flash memory cards, digital versatile discs, Bernoulli cartridges, RAMs, ROMs, and the like.

Program code means comprising one or more program modules may be stored on the hard disk 839, magnetic disk 829, optical disc 831, ROM 824 or RAM 825, including an operating system 835, one or more application programs 836, other program modules 837, and program data 838. A user may enter commands and information into the computer 820 through keyboard 840, pointing device 842, or other input devices (not shown), such as a microphone, joy stick, game pad, satellite dish, scanner, motion detectors or the like. These and other input devices are often connected to the processing unit 821 through a serial port interface 846 coupled to system bus 823. Alternatively, the input devices may be connected by other interfaces, such as a parallel port, a game port or a universal serial bus (USB). A monitor 847 or another display device is also connected to system bus 823 via an interface, such as video adapter 848. In addition to the monitor, personal computers typically include other peripheral output devices (not shown), such as speakers and printers.

The computer 820 may operate in a networked environment using logical connections to one or more remote computers, such as remote computers 849a and 849b. Remote computers 849a and 849b may each be another personal computer, a server, a router, a network PC, a peer device or other common network node, and typically include many or all of the elements described above relative to the computer 820, although only memory storage devices 850a and 850b and their associated application programs 836a and 836b have been illustrated in FIG. 8. The logical connections depicted in FIG. 8 include a local area network (LAN) 851 and a wide area network (WAN) 852 that are presented here by way of example and not limitation. Such networking environments are commonplace in office-wide or enterprise-wide computer networks, intranets and the Internet.

When used in a LAN networking environment, the computer 820 can be connected to the local network 851 through a network interface or adapter 853. When used in a WAN networking environment, the computer 820 may include a modem 854, a wireless link, or other means for establishing communications over the wide area network 852, such as the Internet. The modem 854, which may be internal or external, is connected to the system bus 823 via the serial port interface 846. In a networked environment, program modules depicted relative to the computer 820, or portions thereof, may be stored in the remote memory storage device. It will be appreciated that the network connections shown are exemplary and other means of establishing communications over wide area network 852 may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for disabling recording functionality in a secure area, the system comprising:
a beacon, the beacon configured to:
define the perimeter of a secure area; and
instruct electronic devices within the secure area to inhibit recording functions; and
an electronic device in electronic communication with the beacon.

2. The system of claim 1, wherein the beacon defines the perimeter of the secure area via GPS coordinates.

3. The system of claim 1, wherein the beacon defines the perimeter of the secure area as the transmission range of the beacon.

4. The system of claim 1, wherein the beacon includes a universally unique identifier (UUID) that the electronic device will identify when the electronic device comes in range of the beacon.

5. The system of claim 1, wherein defining the secure area includes creating a gateway to the secure area.

6. The system of claim 1, wherein the recording function includes taking pictures.

7. The system of claim 1, wherein the recording function includes taking video.

8. The system of claim 1, wherein the recording function includes audio recording.

9. The system of claim 1, wherein the electronic device includes a smart phone.

10. The system of claim 1, wherein the electronic device includes a tablet.

11. The system of claim 1, wherein the electronic device includes an optical head-mounted display.

12. The system of claim 1, wherein the electronic device includes an augmented reality device.

13. The system of claim 1, wherein the electronic device includes a computer.

14. A system for disabling recording functionality in a secure area, the system comprising:
a first beacon, the first beacon configured to:
define the perimeter of a secure area; and
instruct electronic devices within the secure area to inhibit recording functions;
a second beacon, the second beacon configured to:
define the perimeter of a secure area; and
instruct electronic devices within the secure area to inhibit recording functions; and
an electronic device in electronic communication with the beacon.

15. The system of claim 14, wherein the position of the electronic device within the secure area is determined using trilateration.

16. The system of claim 14, wherein the position of the electronic device within the secure area is determined using triangulation.

17. The system of claim 14, further comprising:
a third beacon, the third beacon configured to:
define the perimeter of a secure area; and
instruct electronic devices within the secure area to inhibit recording functions.

18. A method of disabling recording functionality in a secure area, the method comprising:
setting a perimeter, wherein the perimeter defines a secure area;
defining a protocol for the secure area defined by the perimeter, wherein the protocol which activities are to be blocked within the secure area;
detecting any electronic devices within the secure area; and
sending the protocol to the detected electronic devices.

19. The system of claim 18, wherein the perimeter includes a room entered through a set gateway.

20. The system of claim 18, wherein the beacon communicates with electronic devices using Bluetooth low energy signals.
